(19) United States
(12) Patent Application Publication
(10) Pub. No.: US 2002/0184494 A1
(43) Pub. Date: Dec. 5, 2002

(54) Methods for using embedded printer description language as a security tool and printers and systems with whcih the method may be used

(76) Inventor: Emad M. Awadalla, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/873,867

(22) Filed: Jun. 4, 2001

(51) Int. Cl. H04L 9/00

(52) U.S. Cl. 713/160

(57) ABSTRACT

A method for encrypting files that are to be transmitted across a computer network, such as s that are to be printed by a network printer. The method includes encrypting the file with a first ice and transmitting the file from the first device, across the computer network, to a second ce. The transferred, encrypted file is accompanied by a destination identifier and may also be accompanied by one or more of a source identifier and a flag. Upon receipt of the file, the second ice decrypts the file. Decryption may be conditioned upon the recognition or validation of one or both of the source identifier and the flag, as well as upon separate entry of a decryption key into the second device. Apparatus and systems for effecting the method are also disclosed.

### FIELD OF THE INVENTION

The present invention relates generally to methods, systems, and apparatus for securely transferring data and, more specifically, to methods for securely transferring data across networks. In particular, the present invention relates to methods, systems, and apparatus for securely transferring data to be printed from a source computer to a network printer.

### BACKGROUND OF THE INVENTION

Technological advances have made the electronic transfer of data a routine practice. As electronic data transfer has become more convenient, so has the desirability of electronically transferring data, including data of a sensitive or confidential nature, across computer networks, such as local area networks (LANs) and wide area networks (WANs), including the Internet.

When data is transferred between two remotely located devices of a computer network, such as from a source computer to a printer, the possibility exists that the data may be intercepted by use of another, unintended recipient device. Unintended recipient devices may include devices that have legally or illegally gained access to the computer network of which the source and intended recipient devices are a part and over which the data is being communicated, or other network devices.

Due to the sensitive nature of much electronically transferred data and the possibility that such data may be inadvertently or intentionally intercepted by an unintended recipient, various techniques have been developed to maintain the desired level of security when sensitive data is electronically transferred. Among these techniques are numerous methods for limiting access to data files that are to be transferred across relatively easily accessible networks, such as the Internet. These access-limiting methods are often referred to in the art as “cryptographic techniques”.

As one example of a well-known cryptographic technique, a user seeking to obtain information may be required to provide the source of such information with a proper identification and one or more passwords before the source will provide access to such information. This type is the type of security that is typically used in obtaining online access to, for example, banking and other financial information, as well as for accessing websites that contain information that may be accessed only by specified users (e.g., paying customers, registered members, etc.).

Alternatively, or in addition to the use of passwords, data files may be encrypted. Encrypted files may contain confidential information or personal information, such as credit card numbers, bank account numbers, financial account balances, and the like. Typically, the sender or recipient of such data would like to maintain the confidentiality or personal nature of such data and, therefore, desires that others are prevented or deterred from accessing such data. Encryption prevents or deters unintended recipients, including those who unintentionally receive data and those who intercept such data while the data is en route from one location to another, from accessing the information contained in such files.

In general, such encryption methods include the use of a particular password or “encryption key” to activate a desired encryption algorithm, which encrypts, or “scrambles” the data. The data may then only be decrypted, or “unscrambled”, by a decryption algorithm when a recipient thereof uses a proper password or encryption key. The password or encryption key that is used to unscramble the data may or may not be the same password or encryption key that was previously used to encrypt the data.

The appropriate decryption keys may also be transferred to an intended recipient of data in a secure fashion. For example, decryption keys may be provided to the recipient by an indirect route and the user's provision of appropriate identification information and/or passwords.

U.S. Pat. No. 5,509,074 to Choudhury et al. (hereinafter “the ‘074 Patent”) discloses methods for protecting electronically published copyrighted data and provides an example of a way in which decryption keys may be provided to an intended recipient of encrypted data. One embodiment of the method disclosed in the ‘074 Patent includes transferring an encrypted .pdf data file from a remote server to a recipient computer by way of a wide area network, such as the Internet. The .pdf data file may then be transmitted, in its encrypted form, only to output devices, such as displays or printers, that are configured to decrypt the data as a bitmap file. In the other embodiment of the method disclosed in the ‘074 Patent, the file server encrypts and transfers a unique, traceable version of the .pdf file to the recipient computer, which decrypts the file as a bitmap file that includes the unique, traceable characteristics of the .pdf file. The bitmap file may then be sent to any desired output device.

The basic architecture of both of the embodiments disclosed in the ‘074 Patent requires the recipient computer to provide a request for a document, along with a verifiable, secured identifier (e.g., a password, credit card number, or other valuable, personal or confidential information) to a copyright server, which then verifies the identity of the recipient computer and directs a separate document server to provide the encrypted .pdf data file to the recipient computer. In order for either the recipient computer or the desired output device associated with the recipient computer to enable the appropriate decryption algorithm and accurately decrypt the encrypted .pdf data file to an unscrambled bitmap file, the appropriate decryption key must be supplied.

In the first embodiment of the method disclosed in the ‘074 Patent, the transmitted data is not encrypted by the computer that transmits the data to the output device but, rather, by a remote source computer. Since the data remains encrypted while within the recipient computer, the data may not be manipulated or proofed by a user prior to output thereof. In the second embodiment of the method of the ‘074 Patent, the data is not securely transmitted between the recipient computer and the output device since the recipient computer decrypts the data before sending it to the output device.

In addition to the risk that data transferred over the Internet may be intercepted, data transfer over smaller computer networks with more limited access and tighter security, including LANs and exclusive WANs, is also becoming more risky. Currently, files that are intercepted by unintended recipient computers from such smaller computer networks can be sent to any output device on the computer network and viewed by the unintended recipient. For example, an unintended recipient device can be used to “hack” into a print queue of either a printer or print server and intercept files temporarily stored therein. It is also possible for an unintended recipient device to mimic the identity of the intended recipient device and, thereby, intercept files that were to be transmitted to the intended recipient device.

Accordingly, there are needs for a method, printing system, and printer by which data that may be encrypted by a source computer and securely transferred directly from the source computer, across a computer network, to a printer.

### SUMMARY OF THE INVENTION

The present invention includes methods for encrypting, or scrambling, data with a first device, such as a source computer, transferring the encrypted data across a computer network to a specified second device, such as a printer, and decrypting, or unscrambling, the data with the second device. Once the second device has decrypted the transferred file, the second device may process and output the file. The present invention also includes systems for effecting the methods, as well as printers and other devices that are configured to properly decrypt and output encrypted data files.

A data transfer method incorporating the present invention includes causing a first device to encrypt a file to be transferred across a computer network and supplying the encrypted file with an identifier for an intended destination device, a second device of the computer network, as well as a flag, or encryption key or code, that will be recognized only by the second device. The encrypted file is then transmitted across the computer network to the specified second device. Upon receipt of the transmitted, encrypted file, the second device evaluates the encryption key or code and, based upon the decryption key or code, executes the appropriate decryption algorithm. Once the second device unscrambles the data, the second device may output the data.

In the method of the present invention, the file may be generated or manipulated by a first device prior to conversion of the file to an appropriate output format or encryption of the file. The file to be transferred may be converted to an appropriate output format (e.g., a known printer description language (PDL) format, such as a postscript format, a .pcl format, a .pdf format, or an .xnl format) and is encrypted by a first device, such as a source computer. Known processes are employed by the first device to convert the file to the appropriate output format.

The first device encrypts the file by use of a suitable encryption algorithm, as known in the art. The encryption algorithm that is employed by the first device is based on the identity of an intended recipient second device to which the file is to be transferred, such as a printer on the same computer network (e.g., a LAN). Either a single encryption algorithm, which is associated with the second device, may be used or the encryption algorithm may be selected from an available set of encryption algorithms. When the encryption algorithm is selected from a set available to the first device, selection may be effected by a user entering a specific encryption key, or password, that corresponds to the employed encryption algorithm, or based on another factor, such as the date, the type of file to be printed, the size of the file to be printed, or the like. Each first device on the computer network may have available thereto a different encryption algorithm or set of encryption algorithms that correspond to a specific second device than the algorithm or algorithms that correspond to the same second device and are available to other first devices of the same computer network.

Each device of a computer network typically has a substantially unique identifier. Source and destination identification data representative of the identifiers for the first and second devices are added to the file that is to be transmitted across the computer network. Various processes may then be used to transmit the encrypted file from the first device to the intended recipient second device.

Once the encrypted file has been received by the second device, a processor of the second device evaluates the source identifier and applies the appropriate decryption algorithm to decrypt the file. In addition, the second device may require that an appropriate flag accompany the transmitted file or that a decryption key (i.e., password or code) be supplied separately from the encrypted file before the processor of the second device will execute the appropriate decryption algorithm. One or more decryption algorithms may be available to the second device, in which case, the appropriate decryption algorithm is selected from the available set based on one or more of the source identifier, the flag, or the separately entered decryption key.

When a flag accompanies the transmitted, encrypted file, the recipient second device evaluates the flag and selects a corresponding decryption key that enables the second device to execute the appropriate decryption algorithm. The appropriate decryption key may be stored in memory of the second device or input directly into the second device. If the decryption key is provided by the printer itself, the appropriate, corresponding encryption and decryption keys were preferably provided to the first and second devices remotely in time from the transmission of the encrypted file to the second device (e.g., during installation of drivers for the second device on the first device). Once the transmitted, encrypted file has been decrypted, it may be output in a format that is recognizable to the second device or to a user (e.g., by printing).

The present invention also includes systems (e.g., computer networks and the components thereof) that effect the method of the present invention, as well as devices, such as printers, that are equipped to present one or more decryption keys, if necessary, and to decrypt an encrypted file received thereby.

Other features and advantages of the present invention will become apparent to those of ordinary skill in the art through a consideration of the ensuing description, the accompanying drawings, and the appended claims.

### DESCRIPTION OF THE DRAWINGS

In the drawings, which illustrate exemplary embodiments of the present invention:

FIG. 1 is a flow chart illustrating an exemplary process flow incorporating teachings of the method of the present invention;

FIG. 2 is a schematic representation illustrating a network that includes a source computer and a destination printer that are capable of executing the method of the present invention to prevent an unintended recipient, such as a non-network computer that gains unauthorized access to the network, from intercepting files transferred from a source computer to the printer;

FIG. 3 is a schematic representation of a source computer that is configured to carry out the method of the present invention;

FIG. 4 is a flow chart that depicts an exemplary process by which appropriate encryption algorithms may be downloaded onto the source computer of FIG. 3;

FIG. 5 is a flow chart illustrating an exemplary process by which the source computer of FIG. 3 processes a file that is to be transferred from the source computer to a printer or other output device in the same network in accordance with teachings of the present invention;

FIG. 6 is a schematic representation of a printer incorporating teachings of the present invention, which printer is configured to decrypt files that are encrypted in accordance with teachings of the present invention; and

FIG. 7 is a flow chart depicting an exemplary process by which the printer of FIG. 6 decrypts files that have been encrypted in accordance with a method according to the present invention.

### DETAILED DESCRIPTION OF THE INVENTION

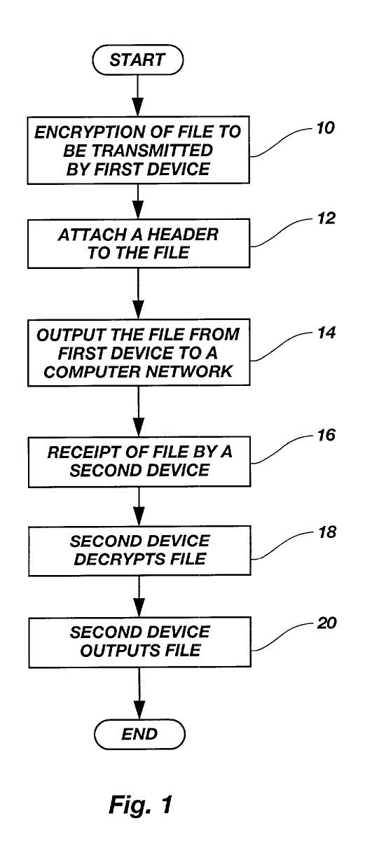

In one aspect and as depicted in the flow chart of drawing FIG. 1, the method of the present invention includes encrypting a file to be transferred from a first device of a computer network to a second, intended recipient device of the same computer network, as shown at reference character 10. At reference character 12, a flag or code is attached to the file header, which also includes information regarding the intended destination of the file, as well as information about the characteristics of how the file is to be output.

At reference character 14, the encrypted file is output from the first device to be transferred via the network. The encrypted file is then received, at reference character 16, by the intended second device. The intended second device, which is configured to acknowledge the flag or code that was transferred along with the encrypted file, has one or more decryption algorithms available thereto. Upon receiving an encrypted file from the network and “recognizing” the source of the encrypted file, an acceptable or authorized flag or code, a separately entered decryption key, or any combination thereof, the second device initiates the appropriate decryption algorithm, at reference character 18, to decrypt, or unscramble, the encrypted file. Finally, at reference character 20 of drawing FIG. 1, the file may be output in a form that may be viewed and more easily understood by a user. For example, the file may be printed onto a sheet of paper as one or more images or characters.

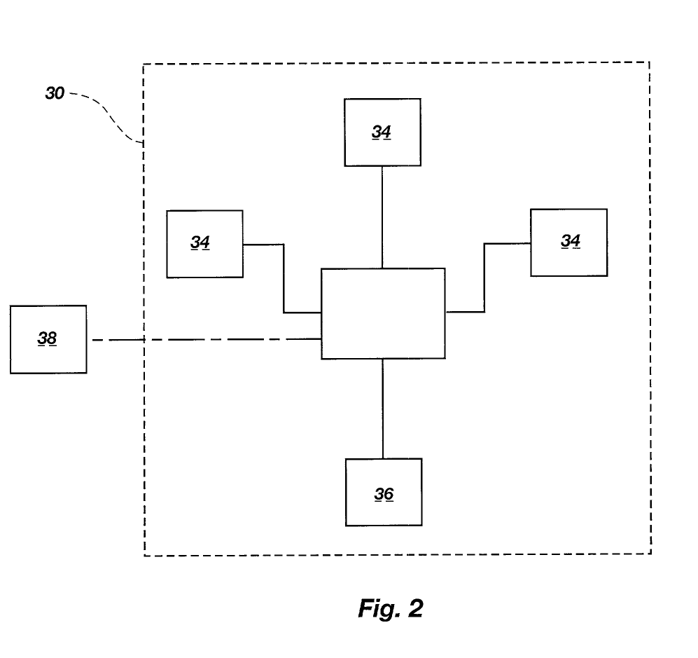

Turning now to drawing FIG. 2, a computer network 30 is illustrated. Computer network 30 may be a local area network (LAN) or a wide area network (WAN), including, without limitation, the Internet, or any other known type of computer network. Computer network 30 includes a first device 34, such as a source computer, and a second device 36, such as a printer, the appropriate driver (i.e., output control program) for which has been installed, or downloaded, onto first device 34. Also depicted in drawing FIG. 2 is a non-network computer 38 that has gained unauthorized access to computer network 30.

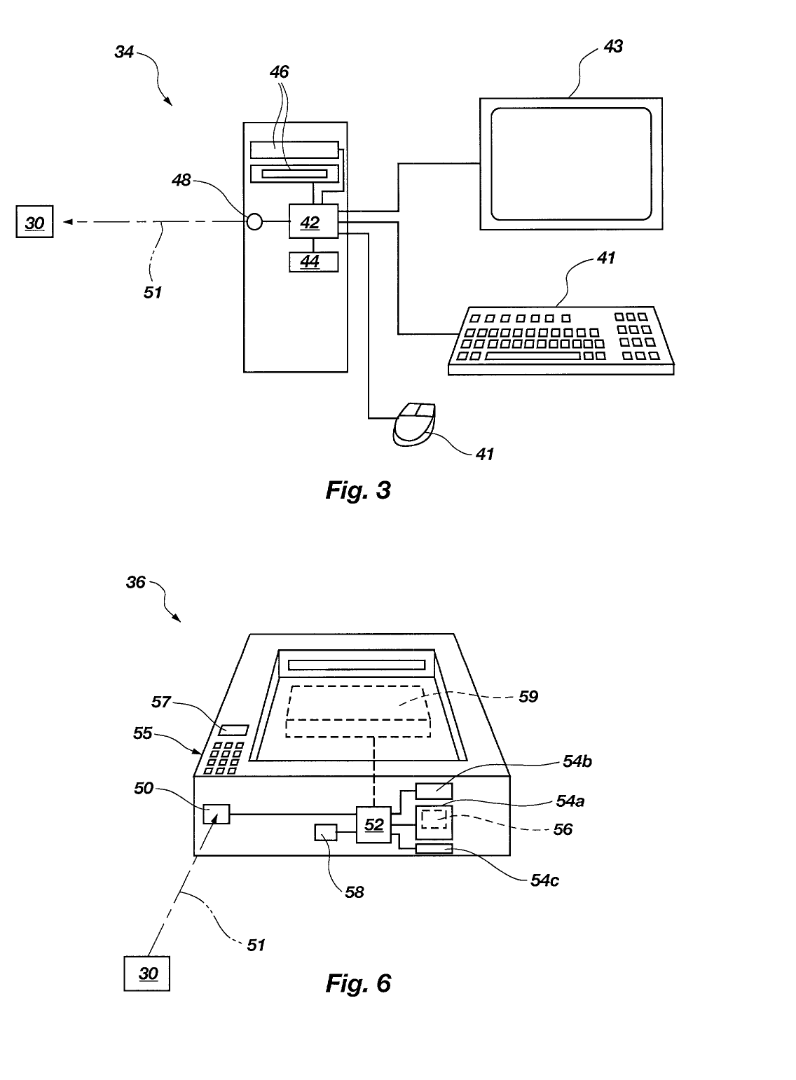

In drawing FIG. 3, a first device 34, such as a source computer, is illustrated. First device 34 includes a processor 42, as well as memory 44, at least one disk drive 46, and a communication element 48 associated with processor 42. First device 34 may also include an input component 41, such as a computer keyboard or mouse, and an output element 43, such as a video monitor, both of which communicate with processor 42.

By way of example, memory 44 may comprise random-access memory (RAM), read-only memory (ROM), a hard disk drive, any other known type of memory device, or any combination thereof.

Communication element 48 may comprise a communication port (e.g., a serial, parallel, USB, infrared, etc.), a network interface, a modem (e.g., 56K, DSL, cable, T1, etc.), or any other known device for establishing communication between a computer and either local or remote (via a computer network 30) external devices. When first device 34 is part of a computer network 30 (FIG. 2), such as a LAN or WAN, communication element 48 and communication links 51 of known types, which include but are not limited to electrical and electromagnetic signals, or carrier waves, convey data to and from first device 34.

Processor 42, under control of an output control program, causes one or more files to be output from first device 34 when given an instruction or command to do so. In the present invention, processor 42 of first device 34 also executes an encryption algorithm, which causes processor 42 to encrypt the file or files to be output. The output control program and the encryption algorithm may be separate from one another or combined in a single program. Encryption software that incorporates teachings of the present invention is used in conjunction with the output control software in such a manner as to only encrypt a file or files to be output by use of an encryption algorithm that corresponds to a decryption algorithm that is available to and which may be unique to the intended second device 36.

Such software may be permanently or temporarily stored in memory 44 of first device 34, such as on a hard drive, in random-access memory (RAM), or on a disk that may be “read” by a disk drive 46 of first device 34. Alternatively, the output control program and the encryption algorithm may be embodied as firmware or hardware, as known in the art. Also, separate processors 42 may be used to control the output of one or more files and to encrypt the file or files that are to be output.

By way of example, when it is desired that a file be printed, as indicated by a user's instruction to print the file, the output control program may take the form of print driver software that causes processor 42 of first device 34 to convert the file to be transmitted to an appropriate format (e.g., a PDL format) for recognition by a recipient printer (i.e., second device 36). The print driver software may also cause processor 42 to “label” the file to be transmitted with data that identifies first device 34 as the source of the file, as well as with data that indicates the intended recipient second device 36 and which will cause the intended recipient second device 36 to receive the file, as known in the art. In addition, data regarding desired characteristics of the file (e.g., the number of copies to be printed, the output format or paper size for the output file, etc.) may accompany the file to be transmitted from first device 34 to second device 36. When the file is to be printed, such data is typically referred to as a “print header” of the converted (e.g., PDL) file.

Continuing with the example of outputting a file to a printer, processor 42, under control of the encryption algorithm, encrypts, or “scrambles”, the file. An encryption algorithm is used that corresponds or is reciprocal to a decryption algorithm that may be used by the printer (i.e., second device 36) by which the encrypted file is to be received.

The print header of the encrypted file remains unscrambled and may include a flag or code that is presented to second device 36 (e.g., a printer) before second device 36 will decrypt the remaining, scrambled portion of the file. Of course, the flag or code corresponds to and may be read only by a printer that is part of the same network as the computer from which the file was sent. The modifications that may be made to the printer driver to include such a flag or code in the print header are well within the skill of one in the art. The codes may be specific to and even unique to the intended target second device 36 (e.g., printer) to which the encrypted file is to be sent. Consequently, a file that has been encrypted in accordance with teachings of the present invention must be received by the intended second device 36 (e.g., a printer) (FIG. 2) to be output in an intelligible, unencrypted format.

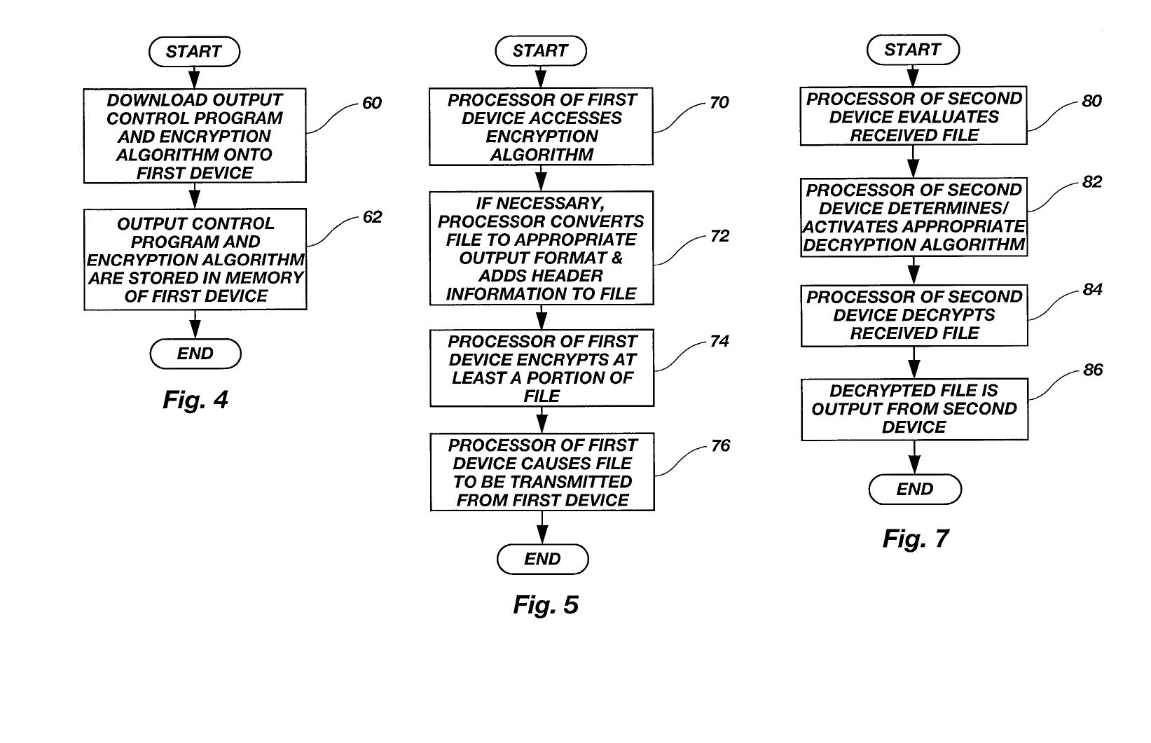

An encryption algorithm that is complementary to the decryption algorithm of a particular second device 36 and the corresponding flags or codes may be introduced into (e.g., downloaded onto) first device 34 when output control programming (e.g., a printer driver) that corresponds to a specific second device 36 (e.g., a printer) is introduced into (e.g., downloaded onto) first device 34, such as by the process illustrated in the flow chart of drawing FIG. 4. By way of example and not to limit the scope of the present invention, at reference character 60 of drawing FIG. 4, the output control software and encryption algorithm that correspond to a particular second device 36 that is linked to computer network 30 may be downloaded onto first device 34. Preferably, the output control program and encryption algorithm are stored on a disk (e.g., a CD-ROM, floppy disk, etc.) that is packaged by the manufacturer with second device 36 or that otherwise corresponds specifically to a particular second device 36. The output control program and encryption algorithm may be downloaded onto first device 34 by inserting a disk containing the same into a disk drive 46 of first device 34. Upon downloading, as indicated at reference character 62 of drawing FIG. 4, the output control program and encryption algorithm may be stored in memory 44 of first device 34, where they are made available to processor 42 upon entry of an output command either by programming of processor 42 or by way of an output command by a user.

Alternatively, a first set of encryption algorithms that corresponds to a second set of decryption algorithms available to a particular second device 36 of computer network 30 may be introduced into first device 34. Upon use of one of the encryption algorithms of the first set by first device 34 to encrypt a file and receipt of the encrypted file from first device 34, second device 36 may select the appropriate decryption algorithm from the second set and decrypt, or unscramble, the transmitted encrypted file prior to outputting the same. Of course, if multiple encryption and decryption algorithms are respectively available to first and second devices 34,36, a flag is necessary in addition to the source identifier to facilitate selection of the appropriate decryption algorithm from the second set.

Turning now to the flow chart of drawing FIG. 5 and with continued reference to drawing FIG. 3, upon being directed to output (e.g., print) a selected file, processor 42 of first device 34 accesses the output control program and the encryption algorithm from memory 44, as indicated at reference character 70 of drawing FIG. 5. In the event that more than one encryption algorithm is available to processor 42, the encryption algorithm that is used by processor 42 may be selected either in response to a user- or processor-generated command or randomly. At reference character 72 of drawing FIG. 5, processor 42, under control of the output control program, converts the file to be output to an appropriate format (e.g., a PDL format) and adds data regarding desired characteristics of the file (e.g., the number of copies to be printed, the output format or paper size for the output file, etc.) and an identifier for the intended recipient second device 36 (e.g., a printer) to the file to be output. In addition, at reference character 74 of drawing FIG. 5, processor 42, in accordance with the instructions provided by the encryption algorithm, encrypts the file to be output. The converted, encrypted file is then output by processor 42, at reference character 76 of drawing FIG. 5, by way of communication element 48.

Once the converted, encrypted file has made its way onto computer network 30 (FIG. 2), it may be received by a second device 36 that is also a part of computer network 30. FIG. 6 illustrates an exemplary printer embodiment of a second device 36 incorporating teachings of the present invention. The printer embodiment of second device 36 that is depicted in FIG. 6 includes a communication port 50, at least one processor 52 that is configured to control the various functions and tasks to be carried out by second device 36, as well as one or more memory devices 54 associated with processor 52. In addition, second device 36 may include an input element 55, such as a touch pad or keys, and a video output element 57, such as an LED display, as known in the art. Of course, a printer incorporating teachings of the present invention also includes a conventional printing element 59 (i.e., the hardware that is required for printing), which prints files as directed to do so by processor 52 or an external print server, as known in the art.

Files that are to be printed are communicated to the printer through communication port 50, which may comprise any known type of communication port (e.g., parallel, serial, USB, infrared, etc.), a network interface, a modem, or the like. A printer of the present invention may also output information, such as information about the status of a print job, printer errors, errors in file transmission, and the like, through communication port 50. When the printer is part of a computer network 30 (FIG. 2), such as a LAN or WAN, communication port 50 facilitates linkage of the printer to computer network 30. Linkage of the printer to computer network 30 is effected by means of known types of communication links 51, which are electrical or electromagnetic signals, or carrier waves, that convey data to and from the printer through communication port 50.

In addition, a second device 36 according to the invention, such as a printer, may be provided with at least one uniform resource locator 58 (URL), by which second device 36 is identified on a network. URL 58 may be accessed from a remotely located first device 34 of computer network 30, for example, via HTTP. Additional URLs may be provided for components of the printing device that have differing functions. For example, a URL may be provided for a component of the printing device that is capable of performing facsimile functions.

In the printer embodiment of second device 36, processor 52 may take the form of a conventional printer microcontroller, which, under operation of software stored in a memory device 54, firmware, or preprogrammed hardware, controls printer-specific hardware and software.

Each memory device 54 may comprise RAM 54a, a hard disk 54b, ROM 54c, or any other type of memory device that is known to be useful in a printer. As depicted, a printer according to the present invention may also include combinations of different types of memory devices 54. The printer may be equipped with as much as 64 megabytes of RAM or more, although printers including RAM with less memory are also within the scope of the present invention. One or more memory devices 54 of a printer may be associated with print cache 56, as known in the art, or provided separately from print cache 56.

Executable programs may be stored by memory device 54 or embodied as firmware that is associated and communicates with processor 52. In a printer that incorporates the present invention, the executable programs include one or more decryption algorithms of a known type, as well as known, device-specific (i.e., printer-specific) programs that effect the operation of various hardware components of the printer. While the decryption algorithms may themselves include routines that are configured to recognize or validate a source identifier or flag on the header of an encrypted file and, thus, to recognize or validate the encrypted file as originating from a particular source and to activate a corresponding decryption routine, a source recognition routine may also be embodied as a separate program, which then selects the decryption algorithm appropriate for (i.e., that corresponds to) the source of the encrypted file. As another alternative, only a single decryption algorithm may be available to a particular printer or other type of second device 36, in which case all of the encrypted files that are intended to be received by second device 36 are scrambled using the same encryption algorithm, one which corresponds to the decryption algorithm available to second device 36.

Of course, processor 52 executes the various programs available thereto, as known in the art. As shown in the flow chart of drawing FIG. 7 and with continued reference to drawing FIG. 6, processor 52 of second device 36 may decrypt a file by, first, at reference character 80 of drawing FIG. 7, executing a source recognition routine to evaluate a received, encrypted file, if necessary, to determine and activate the decryption algorithm that corresponds to an encryption algorithm that was executed by processor 42 of first device 34 (FIG. 3), at reference character 82 of drawing FIG. 7. At reference character 84 of drawing FIG. 7, processor 52 operates under control of the appropriate decryption algorithm to unscramble the encrypted file. Next, at reference character 86 of drawing FIG. 7, processor 52 then executes the various device-specific (e.g., printer-specific) programs that are required to output information contained in the file in the desired fashion.

In an exemplary data transfer method of the present invention, a file may be prepared or modified or manipulated on a first device 34 (FGs. 2 and 3), such as a source computer. The file may be manipulated automatically by processor 42 (FIG. 3) or manually by use of input component 41 (FIG. 3), as known in the art. When a user of first device 34 issues instructions to first device 34 that require that the file be transferred to another location on the same computer network 30 (FIG. 2), such as a second device 36 (FIGS. 2 and 6), the file may be provided with a header that identifies second device 36 as the intended recipient and encrypted, as described above. Of course, the header of the file need not be encrypted. It may also be desirable or necessary to convert the file to another format (e.g., a PDL format when the intended recipient second device 36 for the transmitted file is a printer) prior to encrypting the file.

Referring again to drawing FIG. 2, encryption in accordance with the inventive method may occur, for example, when a file is to be printed by a network printer, when the file is to be stored in memory of a server that administers computer network 30, with e-mails that are sent from first device 34 to second device 36, and for any other application that involves the direct transfer of data from a first device 34, across a computer network 30, to a second device 36.

In the example of a file to be printed on a network printer, a user gives a print command, including a designation of an intended recipient second device 36, by entering the same into input component 41 (FIG. 3) of first device 34. Referring now to drawing FIG. 3, processor 42, under control of an output control program, then converts the file to a PDL format appropriate for the intended recipient second device 36 (FIG. 2) and provides the file with a header.

Next, the file is encrypted. If more than one encryption algorithm is available to processor 42, processor 42 may select the encryption algorithm that is to be used either randomly, based on certain predetermined criteria, or by instructions from a user, as entered through an input component 41 of first device 34. Encryption of the file is also effected by processor 42, which acts in accordance with instructions provided by an encryption algorithm available thereto.

Once the file has been encrypted, processor 42, again under control of the output control program, causes the file to be transmitted, in the form of a communication link 51 through communication element 48 of first device 34 and across computer network 30. Turning now to drawing FIG. 6, upon receipt of the file from computer network 30 by the intended recipient second device 36, a printer in this example, via communication element 50 thereof, the file is removed from computer network 30.

When the printer has received the transmitted file, the encrypted portion or portions of the file may be decrypted. Decryption is effected by processor 52 of the printer (i.e., second device 36) in accordance with instructions provided by a decryption algorithm available thereto. Decryption may comprise either or user-initiated automatic activation of a single decryption algorithm available to the printer. Alternatively, decryption may be based on recognition by processor 52 of one or more of a source identifier or a flag that are part of the file header, or a decryption key that may be entered into the printer separately from the transmitted file (e.g., by way of input element 55). Such recognition may be required to activate a single decryption algorithm available to the printer, or to facilitate selection and activation of an appropriate decryption algorithm from a set of decryption algorithms that is available to processor 52. Processor 52 then operates under instructions from the activated decryption algorithm to decrypt, or unscramble, the encrypted portions of the file.

Finally, the decrypted file may be printed, as known in the art.

The method of the present invention may be carried out on a variety of levels. At one level, all data transmitted across computer network 30 (FIG. 2) from first device 34 to a particular second device 36 may be at least partially encrypted. At another level, a flag, code, or source- or destination-identifying data may be provided in the header of the file to be transferred or otherwise embedded within the file to be transferred. At yet another level, entry of an additional password into second device 36 could be required before second device 36 will unscramble and further process the file.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed is:

1. A method for securely transmitting data between a computer and a printer, comprising:
converting a file for printing to a printer description language format;
encrypting said file in said printer description language format;
providing said file with an identifier for the printer; and
transmitting said file to the printer.

2. The method of claim 1, further comprising decrypting said file by the printer.

3. The method of claim 1, wherein said converting comprises converting said file to at least one of a postscript format, a .pcl format, a .pdf format, and an .xml format.

4. The method of claim 1, further comprising:
receiving said file by the printer, the printer recognizing said identifier, validating said identifier, and selecting an appropriate decryption algorithm.

5. The method of claim 4, wherein said providing includes providing said file with a flag recognizable solely by the printer for indicating an encryption algorithm for use in said encrypting.

6. The method of claim 5, wherein said providing comprises providing said file with a flag stored in a memory of the computer.

7. The method of claim 5, further comprising at least one of recognizing said flag, validating said flag, and selecting an appropriate decryption algorithm.

8. The method of claim 7, wherein said validating includes entering a decryption key into the printer.

9. The method of claim 8, wherein said entering comprises entering a decryption key corresponding to said flag.

10. The method of claim 2, wherein said decrypting comprises selecting an appropriate decryption algorithm from a plurality of decryption algorithms available to the printer based upon at least one of an identifier for the computer and a flag provided with said file.

11. A method for securely transmitting data between a first device and a second device in a computer network, comprising:
encrypting a file for transmitting by the first device;
providing an identifier for said file; and
transmitting said file from the first device to the second device.

12. The method of claim 11, further comprising:
decrypting said file by the second device.

13. The method of claim 12, further comprising:
employing one of a plurality of encryption programs available to the first device;
providing said file with an identifier for the first device; and
performing at least one of recognizing said identifier for the first device, validating said identifier for the first device, and selecting an appropriate decryption algorithm from a plurality of decryption algorithms.

14. The method of claim 13, wherein said providing said identifier for said file includes providing a flag for said file, said flag recognizable only by the second device and indicating an encryption algorithm.

15. The method of claim 14, wherein said providing said flag comprises providing a flag for said file stored in memory of the first device.

16. The method of claim 15, further comprising performing at least one of recognizing said flag, validating said flag using a decryption key corresponding to said flag of the second device, and selecting an appropriate decryption algorithm from said plurality of decryption algorithms.

17. A system for securely transmitting a file in a computer network, comprising: a first device including at least one processor for providing an encrypted file with an identifier for transmitting on said computer network; and
a second device including at least one processor for decrypting and outputting the file.

18. The system of claim 17, wherein said at least one processor of said first device includes at least one encryption algorithm.

19. The system of claim 18, wherein said at least one processor of said first device further includes a source for identifiers and flags recognizable solely by said second device for providing the file with at least one of an identifier and a flag for indicating an encryption algorithm for encrypting the file.

20. The system of claim 19, wherein said second device further includes an input element for entry of a decryption key separately from receipt of the file, said decryption key for recognition by said at least one processor of said second device and for corresponding to at least one decryption algorithm available to said at least one processor of said second device and a flag accompanying the file.

21. The system of claim 17, wherein said first device comprises a computer and said second device comprises a printer, said first device having apparatus for converting the file to an output format including a printer description language.

22. The system of claim 17, wherein said first device includes at least one encryption algorithm for corresponding to a decryption algorithm available to said second device remotely in time from transmission of the file across the computer network.

23. A printer, comprising:
at least one processor for receiving an encrypted file for printing from a computer and for receiving at least an identifier for said printer accompanying said encrypted file, said at least one processor for executing a decryption algorithm to decrypt said encrypted file after receipt of said identifier; and
at least one printing element for printing at least files decrypted by said at least one processor.

24. The printer of claim 23, further comprising a memory connected to said at least one processor for storage of said decryption algorithm.

25. The printer of claim 23, further comprising: at least one decryption algorithm associated with said at least one processor.

26. The printer of claim 23, wherein said at least one processor recognizes at least one of an identifier associated with a particular source and a flag recognizable only by the printer and indicative of an encryption algorithm for encrypting said encrypted file.

27. The printer of claim 26, wherein said at least one processor selects a decryption algorithm for decrypting said encrypted file upon recognizing said at least one of said identifier and said flag.

28. The printer of claim 26, further comprising an input element configured for receiving decryption key, said decryption key corresponding to said flag for facilitating recognition thereof.

29. The printer of claim 28, wherein said decryption key facilitates activation of a decryption algorithm.
